(19) United States
(12) Patent Application Publication
(10) Pub. No.: US 2026/0172703 A1
(43) Pub. Date: Jun. 18, 2026

(54) HARDWARE AND SOFTWARE FRAMEWORK FOR INFRARED DETECTOR EVALUATION

(71) Applicant: Government of the United States as represented by the Secretary of the Air Force, Wright-Patterson AFB, OH (US)

(72) Inventors: Mohammad Vakil, Beavercreek, OH (US); Marc Hoffman, Beavercreek, OH (US); DeJuan Daniels, Dayton, OH (US); David Walker, Dayton, OH (US)

(21) Appl. No.: 19/414,907

(22) Filed: Dec. 10, 2025

Related U.S. Application Data
(60) Provisional application No. 63/735,423, filed on Dec. 18, 2024.

(51) Int. Cl. H04N 25/20; H04N 23/617; H04N 25/78

(52) U.S. Cl. CPC H04N 25/20; H04N 23/617; H04N 25/78

(57) ABSTRACT

A system for evaluating and operating an infrared imaging detector including: a host computational device; a pulse capture electronics (PCE) subsystem communicatively coupled to the host computational device, the PCE subsystem including one or more programmable logic devices; and a read-out integrated circuit (ROIC) coupled to the PCE subsystem. The ROIC operatively connected to a focal plane array (FPA) of infrared detectors. The host computational device is configured to execute a framework for infrared detector evaluation (FIRDE) including: transmitting timing, control, and configuration signals to the ROIC via the PCE subsystem; receiving pixel intensity data from the ROIC via the PCE subsystem; applying one or more user-defined or preconfigured signal processing algorithms to the received pixel intensity data; and rendering, analyzing, or storing image frames together with associated ROIC configuration parameters.

### RIGHTS OF THE GOVERNMENT

The invention described herein may be manufactured and used by or for the Government of the United States for all governmental purposes without the payment of any royalty.

Pursuant to 37 C.F.R. § 1.78(a)(4), this application claims the benefit of and priority to prior filed co-pending Provisional Application Ser. No. 63/735,423, filed Dec. 18, 2024, which is expressly incorporated herein by reference in its entirety.

### FIELD OF THE INVENTION

The present invention relates generally to hardware and software frameworks for evaluation of detectors and, more particularly, to hardware and software frameworks for evaluation of infrared detectors.

### BACKGROUND OF THE INVENTION

A commercial, off-the-shelf (COTS) turnkey imaging system will generally include three subsystems: an optical front end including one or more lenses configured to focus incoming radiation onto a focal plane array (FPA) and a readout integrated circuit (ROIC) bonded to the FPA; pulse capture electronics (PCE) that capture and perform signal processing of incoming intensity data (or pixel intensity data) from the optical front end; and a data acquisition and control (DAQ-C) subsystem. Additionally, the COTS imaging system can include vendor-developed software that enables the hardware components to send one or more control parameters to, and receive data from, a specific ROIC via the PCE. This vendor-developed software can be difficult or impossible to generally interface with, making the COTS system unusable or adaptable for many applications. Hence, new systems that make COTS imaging systems usable and adaptable for a wider range of applications may be required.

### SUMMARY OF THE INVENTION

The present invention overcomes the foregoing problems and other shortcomings, drawbacks, and challenges of interfacing with imaging systems, especially infrared detectors. While the invention will be described in connection with certain embodiments, it will be understood that the invention is not limited to these embodiments.

To the contrary, this invention includes all alternatives, modifications, and equivalents as may be included within the spirit and scope of the present invention.

According to one embodiment of the present invention a system for evaluating and operating an infrared imaging detector includes a host computational device; a pulse capture electronics (PCE) subsystem communicatively coupled to the host computational device, the PCE subsystem including one or more programmable logic devices; and a read-out integrated circuit (ROIC) coupled to the PCE subsystem, the ROIC operatively connected to a focal plane array (FPA) of infrared detectors, wherein the host computational device is configured to execute a framework for infrared detector evaluation (FIRDE) including: transmitting timing, control, and configuration signals to the ROIC via the PCE subsystem; receiving pixel intensity data from the ROIC via the PCE subsystem; applying one or more user-defined or preconfigured signal processing algorithms to the received pixel intensity data; and rendering, analyzing, or storing image frames together with associated ROIC configuration parameters.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows an exemplary passive electro-optical and infrared imaging system.

FIG. 2 shows a hardware and software framework for infrared detector evaluation (FIRDE) system, according to one or more embodiments shown and described herein.

FIG. 3 shows additional aspects of the FIRDE system of FIG. 2.

FIG. 4 shows additional aspects of the FIRDE system of FIG. 3.

FIG. 5 shows additional aspects of the FIRDE system of FIG. 3 including, among other things, a process of image formation.

FIG. 6 shows additional aspects of the FIRDE system of FIG. 3 including, among other things, a file formatting scheme.

FIG. 7 shows additional aspects of the FIRDE system of FIG. 3 including, among other things, a network for operating multiple FIRDE systems that can include features similar to the features shown in FIG. 3.

FIG. 8 shows a diagram for receiving and sending intensity data with a FIRDE system that can include features similar to the FIRDE system shown in FIG. 3.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

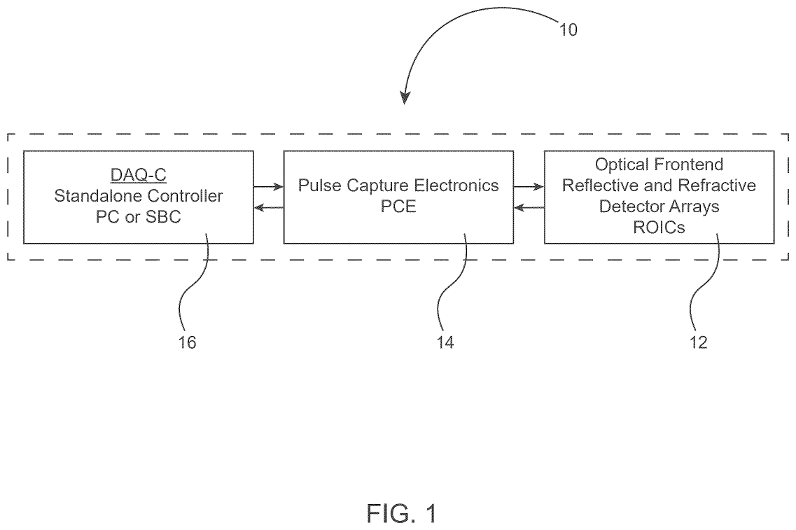

As mentioned above, passive electro-optical and infrared (EO/IR) image systems such as the exemplary passive EO/IR system 10 shown in FIG. 1, in general, consist of three subsystems: an optical front end including one or more lenses configured to focus incoming radiation onto a focal plane array (FPA) and a readout integrated circuit (ROIC) bonded to the FPA; pulse capture electronics (PCE) that capture and perform signal processing of incoming intensity data from the optical front end; and a data acquisition and control (DAQ-C) subsystem. The exemplary passive EO/IR system 10 shown in FIG. 1 includes an optical front end 12, a pulse capture electronics (PCE) 14, and a backend data acquisition and control (DAQ-C) subsystem 16, which could be, for example, a laptop, desktop, tablet, or other form of single board computer(s) (e.g., a host computational device).

The optical frontend 12 can consist of a single lens or multiple lenses that focus incoming light onto an FPA. The FPA includes a detector array and can be bonded to an ROIC. The detector array senses the optical radiation from the lens and transduces it into a voltage or current signal. The ROIC reads the transduced signal levels generated by optical radiation and enables the performance of the optical frontend. In embodiments, the only way to control the detector array portion of an FPA is through the ROIC. Therefore, the ability to interface with, control, and test ROICs for system design is essential.

The next subsystem is the PCE 14, which captures and performs signal processing on incoming intensity data from the optical front end 12. Intensity data is the light or optical radiation (e.g., visible or infrared (IR spectrum) radiation) that is sensed by a detector array that transduces it into an electrical signal. These signals are generated by each of the detectors with the output amplitude varying proportionally to the amount of light received.

After processing in the PCE 14, the intensity data is sent to the third subsystem, which is generally a backend DAQ-C subsystem 16. The DAQ-C subsystem 16 enables a personal computer (PC) or single board computer (SBC) to display an image or perform post-capture analysis.

The PCE 14 also provides the timing and control signals for the operation of the ROIC. The most common ways the PCE 14 can accomplish this is by preprogramming the timing and control parameters on an on-board processor on the PCE 14 or take user inputs from DAQ-C subsystem 16 and then apply them to the ROIC. The PCE 14 can also use a combination of these two methods to provide timing and control for the operation of the ROIC.

As mentioned above, a commercial, off-the-shelf (COTS) turnkey imaging system (e.g., an IR camera used for measuring spectral response of glass, plastics, and other materials, etc.) will generally include all the hardware components (e.g., the pulse capture electronics and/or timing & control hardware (which can be part of pulse capture electronics)). Additionally, the COTS system can include software that enables the hardware components to send one or more control parameters to, and receive data from, a specific ROIC via the PCE 14. Hence, the control and data acquisition hardware and software are usually a combination of both COTS hardware and a vendor-developed software utility.

However, current systems utilizing a COTS turnkey system may be insufficient for meeting imaging requirements. Majority of ROICs used are COTS, and most of the PCE and rendering hardware or software (part of the DAQ-C) is also COTS which is not specialized towards a certain detector technology. In order to be a turnkey system, the conventionally available PCE is designed to accommodate most general hardware utilizing multiple cards and cable options and is not targeted for a small footprint, low power, or customized for a particular ROIC. These systems may have limiting factors that make them unsuitable for current and emerging ROICs. These limiting factors are explained in greater detail in the following paragraphs.

The conventionally available PCE may not even work for all the optical frontends by the same manufacturer and is extremely unlikely to work without a System re-design for optical frontends by a different manufacturer. The DAQ-C system is limited to a certain data rate and format; the software utility, in general, is geared towards a set number of data formats. While the software may be upgradeable either by paying a Non-Recurring Engineering (NRE) cost or a general maintenance fee, it usually can't be modified for domain-specific signal processing. The inability to employ user preferred software such as Python, R, Matlab, etc. hinders advanced testing of the optical frontends and restricts the user to a standard proprietary interface for designing and configuring tests. The size of these boxes makes them impractical for platforms that are space limited such as UAS and handheld applications. Agile and reconfigurable signal processing hardware requirements whether targeted for particular missions or commercial applications also constitute a much-overlooked system limitation.

The first limiting factor is the data acquisition and control system (hardware and software) is limited to a certain data rate (e.g., ranging from few hundred megabits/sec to multi-gigabits/sec) and specific or fixed data package format; the software utility, in general, is geared towards a set number of data formats. While the software may be upgradeable either by paying a non-recurring engineering (NRE) cost or a general maintenance fee, it also adds schedule delay for developing software modifications and performing verification and validation testing. In general, the method applied in the software can't be modified for domain-specific signal processing.

The second factor is that most proprietary methods will not afford the ability for the user to modify parameters for controlling the ROIC and affecting the detector array.

Most of the parameters for detector and ROIC control are preset to a value, or a small range of values, determined by the developer or recommended by the vendor.

The third factor is the tendency for the proprietary software to have its own application environment for rendering an image. For conducting research, testing, and automated data acquisition via standard software tools such as MATLAB scripts, Python, etc., the researcher must use proprietary software. This may not be the format desired by the user/researcher for analytical application. This requires additional steps/software for conversion into a desirable file format or basic file format that can be utilized by a programming language or application of choice.

The fourth factor that comes into play with COTS systems is the method may also be tied to a specific hardware configuration which might be a card or a chipset. This implies that every time there is a new ROIC to be operated and tested, some hardware related modification may be required in addition to software.

Lastly, the proprietary data acquisition and control utility (DAQ-C) does not allow a user-defined automated image acquisition mode with varying frame size and detector parameters. This requires the user to manually load data and the operation is no longer conducted in real-time. This is critical in testing ROIC operation, detector characterization, detector response, and in medical applications. Additionally, it is also essential for law enforcement and military applications such as intelligence, surveillance, and reconnaissance (ISR), search and rescue, and threat warning/detection.

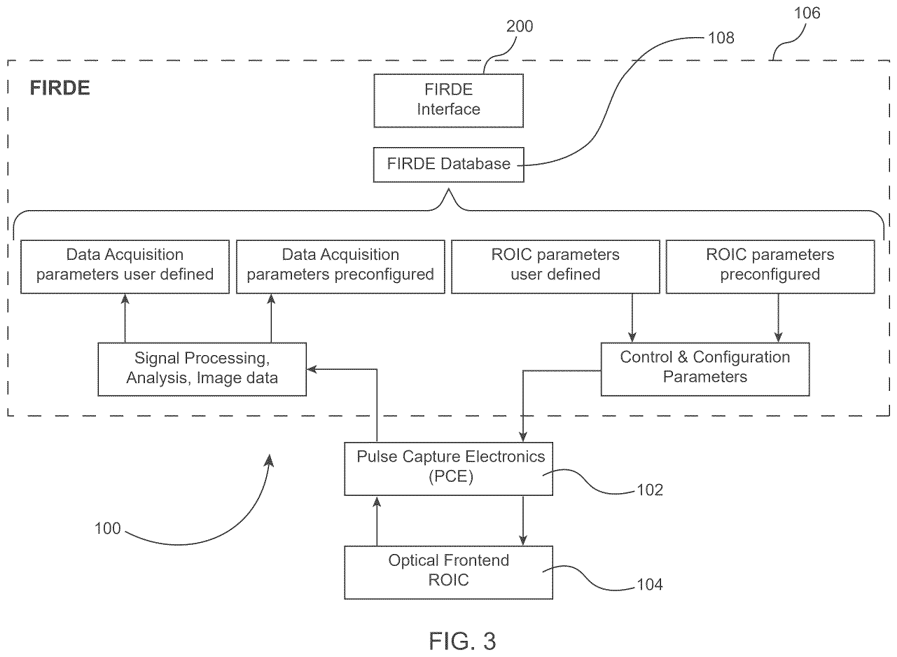

The aforementioned deficiencies are addressed by the hardware and software framework for infrared detector evaluation (or, “FIRDE”) described herein. The FIRDE may be a framework including a system for evaluating and operating an infrared imaging detector. The FIRDE may include custom analytical and signal processing methodologies for imaging systems. FIRDE is comprised of methodologies that enable a user of an imaging system to configure and control an imaging system via a specific ROIC and PCE. It also enables the incoming captured data from the imaging system to be processed, analyzed, and rendered by a standalone controller like a PC, SBC, and other computational devices, per application requirements as shown in FIG. 3.

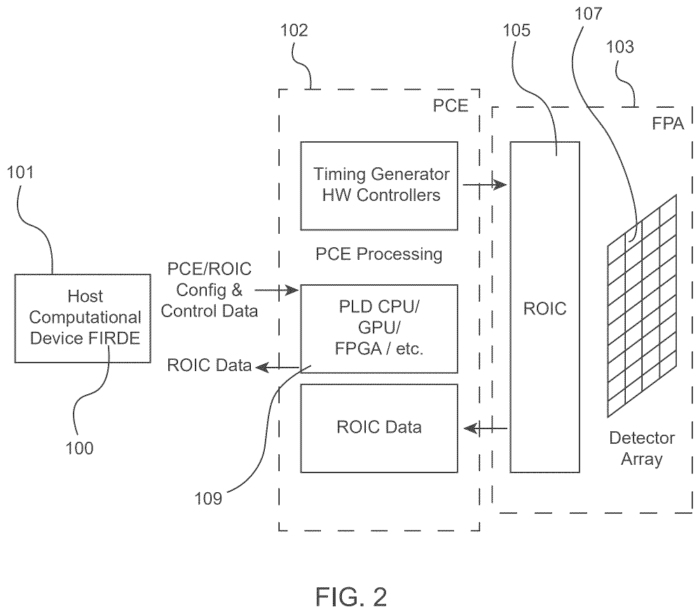

FIG. 2 shows a high level block diagram of the FIRDE framework 100 described herein. FIG. 2 includes a host computational device 101, which may host the FIRDE framework 100. The FIRDE framework 100 may send PCE/ROIC configuration and control data to a PCE 102 and receive ROIC data from the PCE 102. The PCE 102 may be operatively coupled to a focal plane array (FPA) 103, which can include the ROIC 105 and a detector array 107. The PCE 102 can include a programmable logic device (PLD) 109, which may be, for example, a CPU, a GPU, a Field Programmable Gate Array (FPGA), etc.

FIG. 3 shows the FIRDE framework 100 on a computational device 106 with a FIRDE database 108. The computational device 106 is communicatively coupled to a pulse capture electronics (PCE) subsystem (or just PCE 102) and an optical front end 104. The FIRDE framework 100 is capable of implementing methodologies targeted for providing timing, control, and configuration capabilities for the PCE 102 and via the PCE 102 the ROIC of the optical frontend 104 of a passive imaging system such as the FIRDE 100. The optical frontend can have lenses (telescope) and an FPA. This is shown by the unidirectional arrows on the top, taking the timing, control, and configuration (i.e., the Control and Configuration Parameters) data from the FIRDE to the PCE 102 and to the ROIC in the optical frontend 104 via the PCE 102.

The PCE 102 may capture and process a received signal detected by the optical front end 104. The PCE 102 may operate in conventional fashion to condition the received signals and capture information in them, storing information in the PCE 102. In some embodiments, an Analog-to-Digital Converter (ADC) may sample a pulse signal to determine its voltage and analyze its shape. In some embodiments, captured data, including pulse parameters, can be recorded over time for trend analysis and quality control. The conventionally available PCE may not even work for all the optical frontends by the same manufacturer and is extremely unlikely to work without a System re-design for optical frontends by a different manufacturer.

In FIG. 3, the arrows flowing from the ROIC 104 to the PCE 102 and then to the FIRDE computational device 106 indicate a flow of information through these devices.

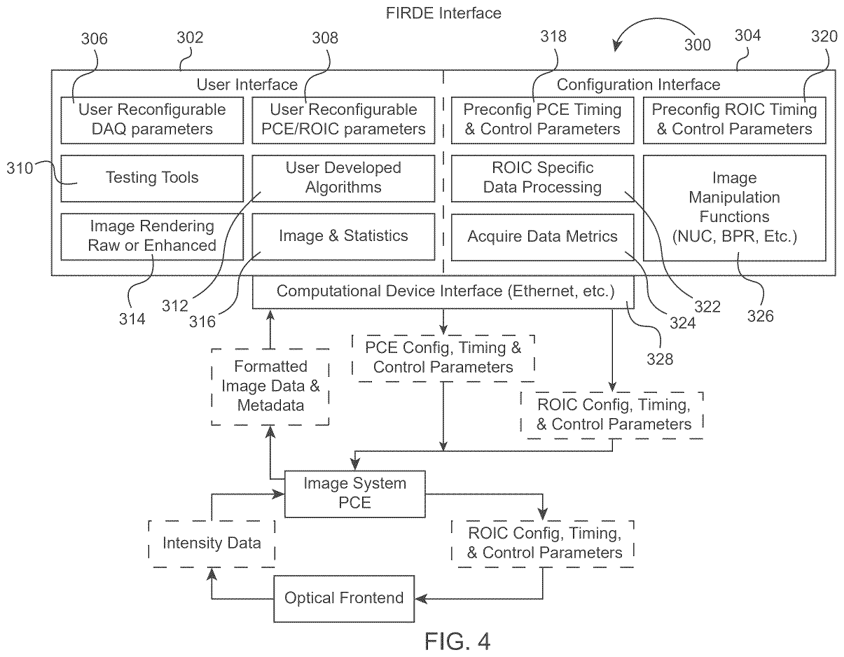

FIRDE provides control for data flow coming as captured intensity output or pixel data from the ROIC 104 into the PCE 102. FIRDE also provides custom analytical, rendering, and signal processing methodologies for data captured by the imaging system. As will be explained in greater detail herein, the FIRDE interface 200 is comprised of User Interface 302 and configuration interface 304, both of which are described herein with respect to FIG. 4. Still referring to FIG. 3, FIRDE provides the capability for the user to add custom or newly developed ROIC configurations, in addition to the existing configurations, to its database 108. This configuration and control data can be implemented on an ROIC via the PCE.

The capability to add custom or newly developed ROICs to function with existing PCE architecture requires two functions. The first function is reconfiguring the PCE to communicate with the ROIC. This entails PCE reconfiguration for receiving data from FIRDE and sending the timing and control signals to the ROIC while also providing the timing and control signal to receive the output data from the ROIC back to FIRDE. Second is the programming of ROIC parameters for the target ROIC such as bias for the detectors, image frame control signals, clocks for timing, and ROIC data out parameters. These various parameters are added via employing User Reconfigurable PCE/ROIC parameter 308 module of the User Interface 302, both shown in FIG. 4.

FIRDE can also provide the capability for users to add custom data acquisition protocols for new or custom ROICs, in addition to the pre-configured data acquisition protocols available. The User Interface 302 shown in FIG. 4 for FIRDE provides a novel adaptive environment for signal processing that allows the users the ability to design and insert their own algorithm 312 as an addition to the system without redesigning the entire system. This process is algorithmic programming language agnostic, as an application programming interface (API) or a “translator file” is used to incorporate/assimilate user developed methods into FIRDE. It also provides the operator of an imaging System the built-in capability to render an image, apply image enhancement techniques such as but not limited noise filters, and collect image statistics. The methods native to the FIRDE environment can also be modified and/or customized to user needs for specific scenario for image collection. This allows FIRDE to be continuously growing and adaptive, and without hindering advanced testing of ROIC data by restricting the users to a proprietary programming method as is the case with current SOTA.

These two capabilities to configure new ROICs and data acquisition protocols enables FIRDE to be adaptive as a framework for an evolving imaging field. For instance, with respect to data rate, it can be dependent on an ROIC manufacturer and/or ROIC model. It may also depend on the varying clock rate a ROIC may accept. However, because FIRDE is designed for embedded and reconfigurable hardware, it is clock and data rate agile depending on the hardware layer between the ROIC and the backend controller that hosts FIRDE. Additionally, while output data format is also dependent on the ROIC manufacturer and/or ROIC model, because FIRDE is targeted for reconfigurable hardware, it can take varying data format information from the vendor and customized embedded design(s) to work with that data format.

FIRDE has a strong focus on compatibility and flexibility with different ROICs and systems. As mentioned before, to accommodate a new ROIC, two operations are required. The first function is reconfiguring the PCE to communicate with the ROIC. This entails both software and firmware to receive, generate, and transmit the data from FIRDE to the ROIC. This is executed by either the Preconfig PCE Timing & Control Parameters 318 or User Reconfigurable PCE/ROIC Parameters 308. The second operation is loading the timing and control parameters for the new ROIC for its operational mode which can either be accomplished by Preconfig ROIC Timing & Control Parameters 320 or User Reconfigurable PCE/ROIC Parameters 308. FIRDE can then initiate start and stop signals for data collection and signal processing. FIRDE can also automate varying frame rates, frame size, detector bias and real-time signal processing for each data collection cycle. If a new ROIC has enhanced operation modes unavailable in other ROICs, FIRDE can configure both the PCE and ROIC to take advantage of new features. This provides a capability lacking in current systems as FIRDE can be tailored for commercial and custom ROIC/PCE systems. Due to this, FIRDE is intentionally setup in a mostly sequential control logic design, to accommodate a diverse class of programmable logic devices (PLDs) such as multiple System on Chip (SoC), GPU, microprocessor (uP), and FPGA architecture configurations (builds).

FIG. 4 shows a block diagram showing an architecture of a FIRDE interface 300. This consists of two overarching subsystems: the user interface 302 for receiving input from and providing information to a user and the configuration interface 304 for timing and control of the PCE and ROIC. The FIRDE interface 300 provides access to the user interface 302 or the configuration interface 304. That is, it enables a user or designer an ability to program and control ROIC programming parameters. In some embodiments, the only way to interface with an optical frontend, such as the optical frontend of FIG. 1, is through an ROIC. That means in order to control imaging sequences, frame sizes, frame rates, etc. a user must be able to control the ROIC interface, which control the FIRDE interface provides.

The user interface 302 includes various modules including, for example, a user reconfigurable DAQ parameters module 306, a user reconfigurable PCE/ROIC module 308, a testing tools module 310, a user developed algorithms module 312, an image rendering raw or enhanced module 314, and an image and statistics module 316. The user interface 302 will allow users the ability to design and insert their own algorithm as an addition to the system without redesigning the system. It also provides the operator of an imaging system the capability to render an image, to apply image enhancement techniques (e.g., noise filters, etc.), and to collect image statistics.

The configuration interface 304 includes a preconfigured PCE timing and control parameters module 318, a preconfigured ROIC timing and control parameters module 320, an ROIC specific data processing module 322, an acquire data metrics module 324, and an image manipulations function module 326. In addition to the preconfigure firmware/software for PLDs, the configuration interface 304 will instantiate (that is, be embodied or implemented such that the hardware is programmed with software or firmware program(s)) the user algorithm in synthesizable logic and downloaded into the PLDs, etc.

That is, in some embodiments, pre-configured firmware/software may be used for enabling hardware to do basic functionality for system operations. If a user wants additional functionality and has developed an algorithm/process that he or she wants to run on the hardware, he or she can do so by using the configuration interface 304.

This will also, on average, increase performance and decrease energy usage, comparatively to a purely CPU-based algorithm. Performance may be enhanced and energy use decreased because a field-programmable gate array (“FPGA”) may only activate its gates when needed to process data, whereas a CPU may be constantly “on.” The FPGA may carry out specialized functions such as, for example, signal processing, AI operations, or just logical processing.

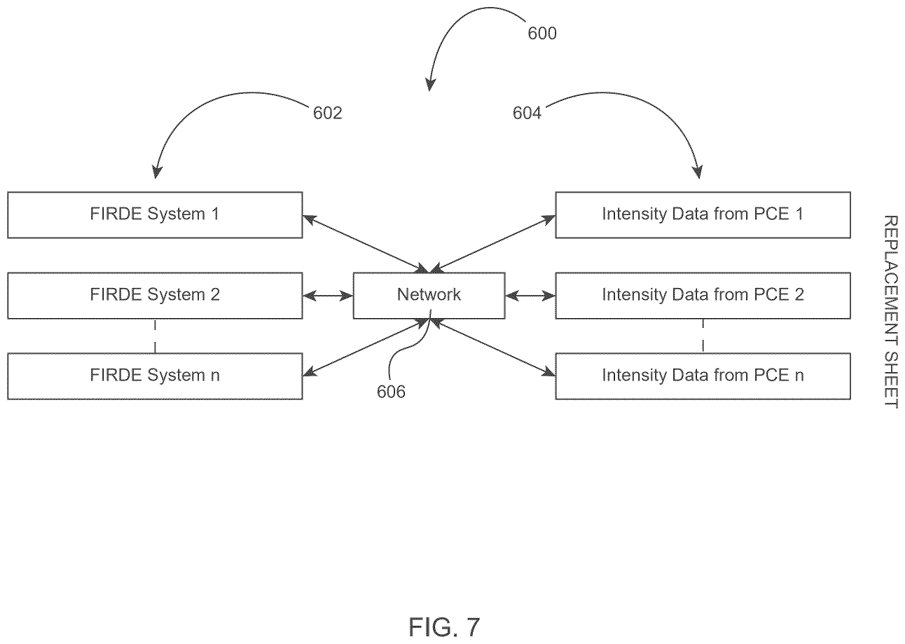

Referring to FIG. 7, flexibility further extends for processes that need to be executed in software, where the SoC can adjust or process the data before being streamed to the desired outlet (e.g., a data storage device, etc.), whether it is being saved locally or to a different device (e.g., a networked computer, etc.) Using a hardware description language or a high-level programming language further allows portability between different PLDs, which may be provided by different PLD vendors.

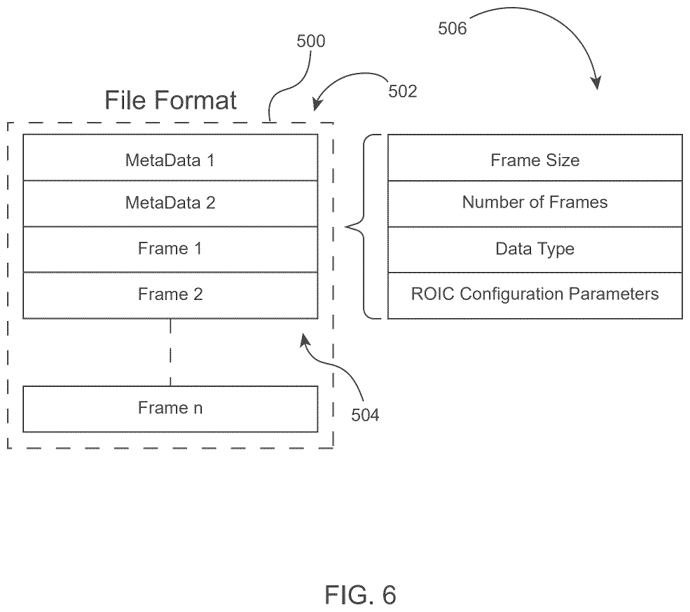

Referring to FIGS. 3 and 6, control signals can be preprogrammed or configured by the user in software using a graphical user interface (GUI) (e.g., the user interface 302) and then sent to the ROIC configuration manager on the PLDs as a configuration structure. This enables multiple configuration settings to be preconfigured and be executed through in real-time depending on the user commands.

Image data can be acquired one frame at a time. There can be one or multiple frames per configuration of the ROIC. Changes to the control signal going to the ROIC can be changed on a frame-by-frame basis, with potential for increased high dynamic range (HDR) capabilities with high frame rates. These settings are sent to the ROIC command manager and are translated into multiple signals that the ROIC would receive through the PCE. These signals will vary, dependent on the ROIC device selected, and will be adjusted by the PLDs automatically.

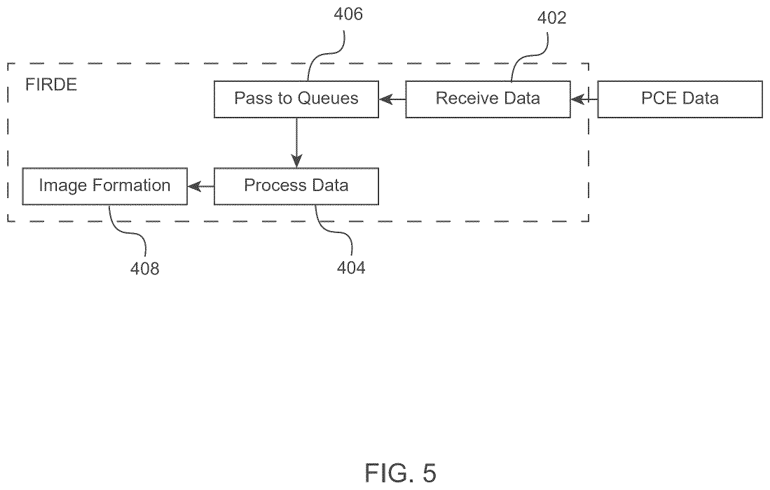

Still referring to FIG. 4, an ethernet connection 328 to a network is utilized to allow for access to potential host devices. The host device can be a PC, SBC or other type of computational platform. The PCEs have an ethernet connection to stream the image data back as described in greater detail herein, especially with respect to FIG. 5.

Still referring to FIG. 4, using an ethernet connection to a network allows multiple FIRDE systems to be active at the same time, allowing for access to the interface of multiple computational devices hosting the FIRDE system simultaneously without having to be directly connected to the device. Data is streamed through a port in the network that the host application monitors. The data sent to the port will be collected and sent into a Queue for further processing.

As shown in FIG. 5, the processes of receiving data 402 and processing data 404 may be split into separate processes, improving throughput of the system by allowing each of them to focus on different tasks as the data streams in. Generally, data from a PCE comes in and gets processed into a host (a backend computer) sequentially. However, in the systems described herein, the FIRDE system may receive and process data using two isolated processes. The data can be received from one or multiple PCEs (step 402) and can be queued into multiple queues (step 406) and processed by different processors (step 404) on the host or on a host network to form an image (step 408). This enhances the processing capability while reducing the processing time. Any changes to the data, such as colormaps and rotations, will be done by isolated processes independent of incoming data streams so that the throughput can be kept high. These images are then displayed for the user via the GUI.

Data points organized into configurable bins or ranges is also available in a graphical format (histogram) to the user for each specific frame to examine the data and compare against other frames. Multiple files can be loaded and contrasted to be more aware of potential saturation and determining the optimal settings for a scene. The histogram will also report relevant statistics, such as the statistical information obtained from the dataset for further validation.

An integrated image viewer will be used for any previously stored data from the stream. This allows for the examination and manipulation of data that has been saved locally, either raw files or files created by the streaming application.

FIG. 6 shows a file format 500 including meta data 502 and frame data 504.

The file format 500 can include other information 506, which can include, as several examples from among many others: frame size, number of frames, data type, and ROIC configuration parameters. Data saved by streaming application will contain additional information (frame size, number of frames etc.). A raw file will save the data directly as a binary, or unsigned n-bit integer data values to name a few.

The image viewer shows the image and includes simple image manipulation functions such as but not limited to thresholding and rotation, as well as some more advanced algorithms, such as but not limited to Non-Uniformity Correction (NUC) and Bad Pixel Replacement (BPR). These algorithms always start with the raw values and are recalculated whenever another function option is added to keep the processing as consistent and accurate as possible.

These tools are used with the intention of either examining the data or improving the quality of the image formed for visual validation. The image viewer can be initiated multiple times, allowing for multiple files to be loaded into memory at once. This, along with the ability to see the actual value of each pixel shown in the screen, allows for further compare/contrast between different settings for the ROIC.

The software testing suite allows the user to run through a series of preconfigured settings to test a wide variety of settings for the connected device. All settings can be modified and are sent sequentially to the connected FIRDE device with the results being saved locally on the host FIRDE device, with each setting saved as individual files.

The settings that were used for each test run will be saved at metadata in the file that is created. Metadata contains additional information pertaining to the included data, such as size, data type, number of frames, etc. This metadata can be loaded and shown into the image viewer software, with the additional ability to only output raw files if needed.

Settings used to create the testing run can be saved and loaded from a file for future reference/analysis.

FIG. 7 shows a multiple FIRDE system architecture 600 that allows multiple FIRDE systems 602 via network connectivity through network 606 to connect or stream data from multiple PCEs 604 via network monitored by the host FIRDE application, allowing multiple FIRDE systems 602 to be active at the same time for image processing.

Simultaneously, the network 606 provides the capability of allowing access for a single FIRDE system to interface with multiple PCEs simultaneously without having to be directly connected to a specific PCE. The multiple PCEs 604 can represent multiple optical frontends 1 through n, producing multiple streams of data, 1 through n. These multiple data streams may be processed by their respective PCEs. The multiple FIRDE systems 602 can serve as hosts 1 through n, each host running the FIRDE framework. If a data stream is generated by a PCE, it's host/respective FIRDE can then task, via the network 606, other available FIRDEs to help out with the processing. This provides load sharing, resource management, and reduction of latency in image processing, analysis, and rendering.

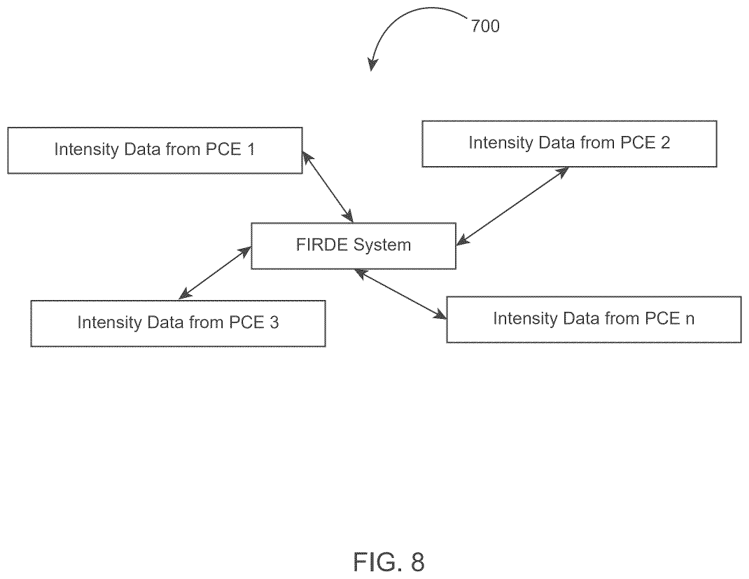

This capability is very useful in resource restricted scenario such as an airborne or spaceborne platform and in a situation where the FIRDE system is cycling through multiple PCEs for imaging systems employed for perimeter security such as in the FIRDE system shown in FIG. 8.

In FIG. 8, a network 700 can include 1 through n optical frontends and corresponding PCEs. As mentioned, the network 700 could include, for example, imaging systems employed for perimeter security or other imaging systems. The FIRDE system 702 can take data from one or all of the PCEs and can process and/or render an image depending on the priority or time of arrival of the data. In this case, depending on the number of activations, the processing time could be slower than the previous scenario depicted in FIG. 6.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described.

Accordingly, departures may be made from such details without departing from the scope of the general inventive concept.

What is claimed is:

1. A system for evaluating and operating an infrared imaging detector, comprising:
a host computational device;
a pulse capture electronics (PCE) subsystem communicatively coupled to the host computational device, the PCE subsystem including one or more programmable logic devices; and
a read-out integrated circuit (ROIC) coupled to the PCE subsystem, the ROIC operatively connected to a focal plane array (FPA) of infrared detectors, wherein the host computational device is configured to execute a framework for infrared detector evaluation (FIRDE) including:
transmitting timing, control, and configuration signals to the ROIC via the PCE subsystem;
receiving pixel intensity data from the ROIC via the PCE subsystem;
applying one or more user-defined or preconfigured signal processing algorithms to the received pixel intensity data; and
rendering, analyzing, or storing image frames together with associated ROIC configuration parameters.

2. The system of claim 1, wherein the PLD comprises one or more of a field-programmable gate array (FPGA), a graphics processing unit (GPU), a system-on-chip (SoC), and a microprocessor (uP).

3. The system of claim 1, wherein the host computational device is further configured to accept user-defined image processing algorithms for execution in real-time on the PCE subsystem.

4. The system of claim 1, wherein the host computational device is further configured to interface simultaneously with a plurality of PCE subsystems across a network.

5. The system of claim 1, wherein the host computational device is further configured to store captured image frames in a file format including both pixel data and metadata describing detector settings, frame size, and timing parameters.

6. The system of claim 1, wherein the host computational device is further configured to enable modification of ROIC control parameters on a frame-by-frame basis.

7. The system of claim 1, wherein the pixel intensity data is received from one or more PCE subsystems and the host computational device is further configured to: queue the pixel intensity data into multiple queues and process the queued pixel intensity data by different PLDs.

8. The system of claim 8, wherein the host computational device is configured such that at least some of the alterations of the pixel intensity data are completed using isolated processes independent of incoming data streams.
